(19) United States
(12) Patent Application Publication
(10) Pub. No.: US 2026/0061803 A1
(43) Pub. Date: Mar. 5, 2026

(54) AI-ENABLED INTERVENTION OPTIMIZATION FOR MAINTAINING TEMPERATURE RANGE IN VEHICLE CABIN FOR REFRIGERATED OBJECTS

(71) Applicant: Volt Air Technologies, PBC, San Francisco, CA (US)

(72) Inventors: Jumana Al Hashal, San Francisco, CA (US); Grant Shatto, III, Milpitas, CA (US)

(21) Appl. No.: 19/309,105

(22) Filed: Aug. 25, 2025

Related U.S. Application Data
(60) Provisional application No. 63/688,707, filed on Aug. 29, 2024.

(51) Int. Cl. B60H 1/00; B60L 1/00; G07C 5/08; H02S 20/30; H02S 40/38

(52) U.S. Cl. CPC B60H 1/00807; B60L 1/003; H02S 20/30; H02S 40/38; G07C 5/0841

(57) ABSTRACT

A control unit mounted within a vehicle having a plurality of individually temperature-controlled regions obtains a set of signals, the control unit spanning at least a portion of each region of the plurality of individually temperature-controlled regions, the control unit configured to control a temperature of each of the regions. The control unit inputs the set of signals into a machine learning model, receives, as output from the machine learning model, for a given region of the plurality of individually temperature-controlled regions, a rate of change of temperature, and determines whether the rate of change of temperature will take a temperature of the given region out of a target range. Responsive to determining that the rate of change of temperature will take a temperature of the given region out of the target range, the control unit performs an intervention on at least one hardware component within the vehicle.

### CROSS REFERENCE TO RELATED APPLICATIONS

This application claims the benefit of U.S. Provisional Application No. 63/688,707, filed Aug. 29, 2024, which is hereby incorporated in its entirety by reference.

### TECHNICAL FIELD

Aspects of this disclosure generally relate to the field of machine learning, robotics, and autonomous systems for temperature-controlled transportation, and more particularly relate to a self-regulating autonomous temperature and energy management system with improved circuitry and processes for optimizing power usage in managing target temperature ranges within temperature-controlled storage compartments in a road vehicle.

### BACKGROUND

Existing refrigerated transport vehicles (known as reefer trucks or trailers) rely on manual control and reactive measures to manage temperature. They typically have a single compartment with a single or small number of temperature zones for goods. If the transport vehicle is electric, the power for both the vehicle propulsion and the refrigeration system (known as a transport refrigeration unit) is typically sourced-from the same main vehicle battery. While such a system enables a refrigerated compartment to maintain a desired temperature, this results in inefficiencies, such as an overburdened multi-purpose power source, hardwiring of parameters such as desired temperature, and lack of ability to proactively optimize for different cargo requirements and external factors (e.g., ambient temperature, sunlight, temperature requirements of different cargo, range limitations, and so on). The need exists for a more intelligent, autonomous system that can use real-time data to anticipate and manage thermal and energy requirements.

### SUMMARY

The disclosed systems and methods provide an autonomous temperature and energy management system for temperature-controlled vehicles. Systems and methods are disclosed herein for a control unit having a dedicated multi-source power supply and a suite of sensors to integrate with and control temperature of a set of compartments on a vehicle creating a self-regulating apparatus. The control unit may draw from multiple sources of energy (e.g., battery, solar panels, electrical grid), may manage different compartments with different target temperature ranges, and may deploy sensors on variables within the compartments and outside of the compartments to optimize power usage relative to maintaining a target temperature until target destinations are reached by the vehicle. In some embodiments, the control unit obtains and fuses live data from both internal and external sensors to autonomously predict a rate of temperature change for each individually temperature-controlled region. In response to these real-time predictions, the system performs an optimized intervention to maintain a target temperature range, managing both thermal and energy loads with a level of autonomy analogous to a self-driving vehicle.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a temperature-control apparatus mounted on a temperature-controlled truck, in accordance with an embodiment.

FIGS. 2A-2C each illustrate one embodiment of temperature-controlled regions within the temperature-controlled truck, in accordance with an embodiment.

FIG. 3 illustrates a process flow for temperature-controlled regions within a storage compartment on a temperature-controlled truck in accordance with an embodiment.

FIG. 4 illustrates exemplary modules and databases for controlling temperature in each temperature-controlled compartment of the truck, in accordance with an embodiment.

FIG. 5 depicts an exemplary process for ensuring temperature in a given region remains in a target range within the temperature-controlled storage compartment of the truck, in accordance with an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

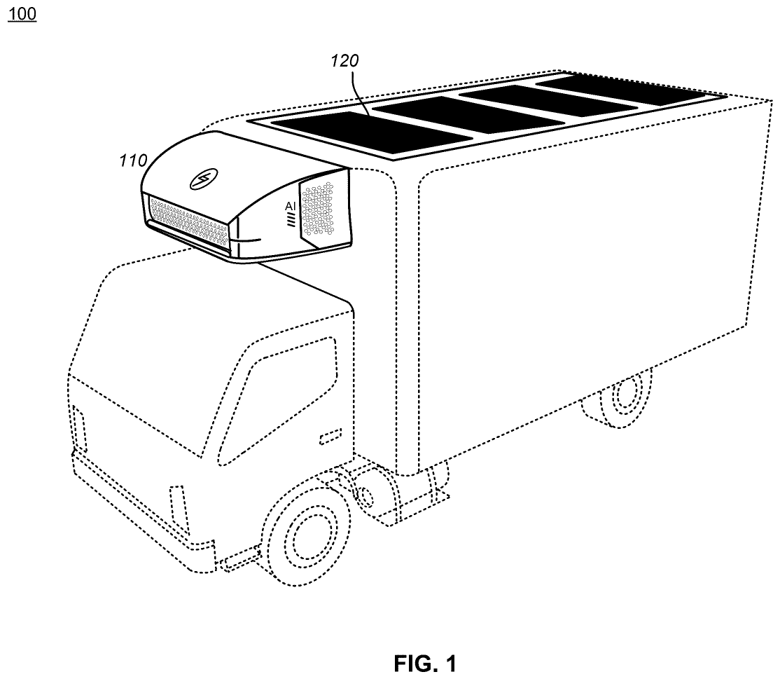

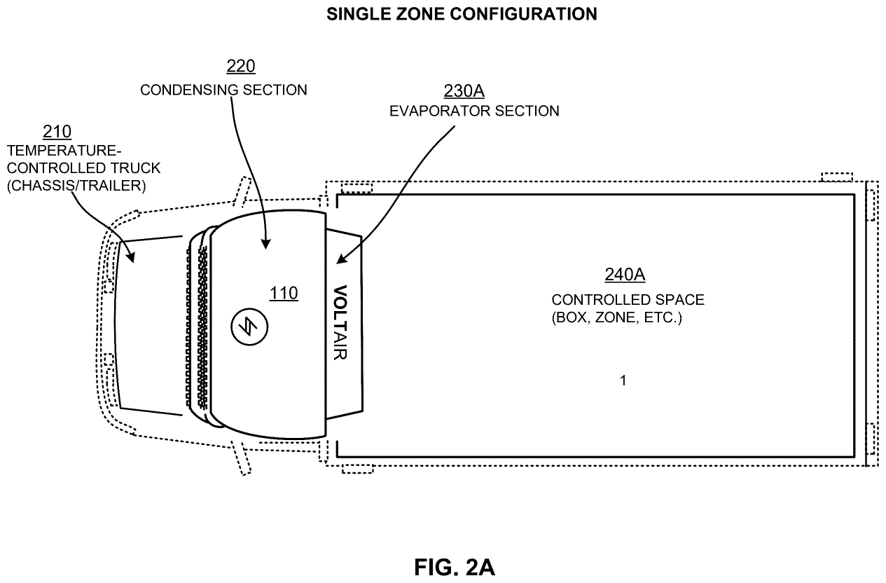

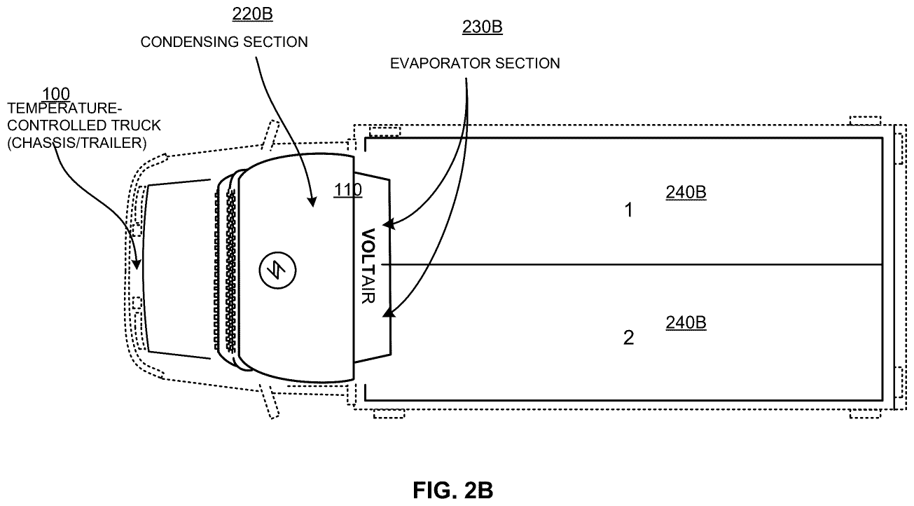

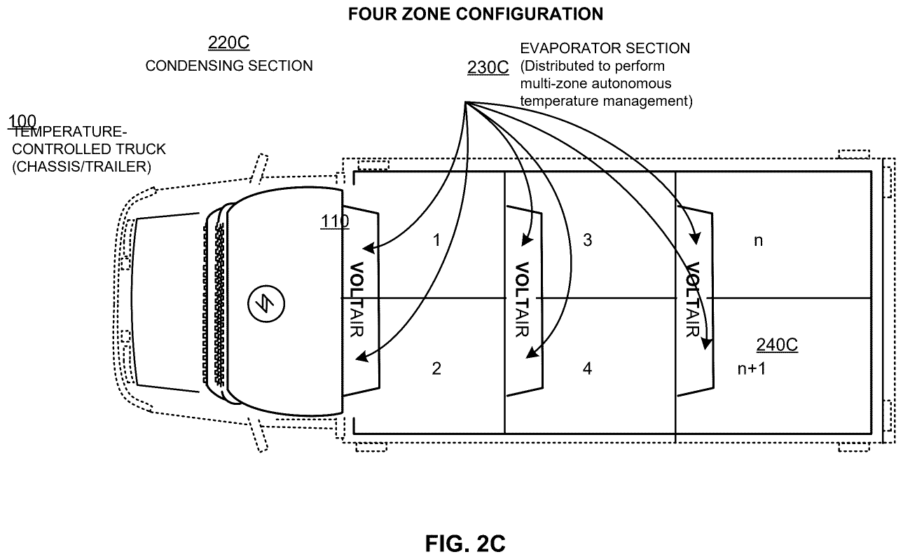

FIG. 1 illustrates one embodiment of a temperature-control apparatus mounted on a temperature-controlled truck, in accordance with an embodiment. As depicted in FIG. 1, temperature-controlled truck 100 includes temperature-control apparatus 110 (which is partially occluded by the truck box, as will be explained in further detail with reference to FIGS. 2A-2C below), and external power source 120. As depicted, external power source 120 includes solar panels; however, other external power sources are within the scope of external power source 120, such as a connection to an electrical grid (e.g., by way of a plug), inductive power sources, and the like. Temperature-control apparatus 110 draws power from external power source 120 in order to refrigerate one or more regions within the truck box. Temperature-control apparatus 110 may additionally draw power from an internal battery used to power motor and other driver operations of temperature-controlled truck 100.

Use of external power source 120 to power temperature-control apparatus 110 amounts to an improvement over existing implementations. Existing systems primarily draw from a truck's integrated battery, thereby putting a drain on that truck's battery that can result in shorter truck battery life and increase risk of an unexpected battery failure that prevents operation of temperature-controlled truck 100. Some existing implementations use a large EV pack that is chassis mounted onto the truck, requiring custom fitting and expensive replacement. External power source 120 is modular, fitting into any temperature-controlled truck as part of a nominal install of traditional temperature-control apparatus 110.

External power source 120 may be designed (e.g., at least the solar panel implementation) to charge and/or maintain low voltage systems. In some embodiments, galvanic isolation is maintained between solar panels and other low voltage buses, providing safety to an operator of temperature-controlled truck 100.

FIGS. 2A-2C each illustrate one embodiment of temperature-controlled regions within the temperature-controlled truck, in accordance with an embodiment. As depicted in FIG. 2A, temperature-controlled truck 100 includes temperature-control apparatus 110, which is comprised of condensing section 220 and evaporator section 230A. Condensing section 220 may house a battery, controls, sensors (e.g., ambient measuring instruments), and the like. Condensing section 220 may transfer heat from evaporator section 230A and expel the heat into ambient air outside of temperature-controlled truck 100. Evaporator section 230A controls temperature within controlled space 240A (e.g., a region within a truck box). Evaporator section 230 may house one or more fans, one or more heat exchangers, one or more thermal cameras, sensors, and so on. Sensors and other components of evaporator section 230 may measure temperatures (including thermal imaging), pressures, humidity, vibrations, CO2, PM, time (e.g., hours or other time ranges to run at specific times of day), power (e.g., electrical watts, voltages, currents in different places of power system, etc.), refrigeration power (e.g., interpolated from compressor speed, temperatures, and pressures), location (e.g., GPS location), elevation (e.g., altitude), Ethylene, and so on. In some embodiments, temperature-control apparatus 110 includes a heat pump capable of both refrigeration and heating within a region. FIG. 2A differs from FIGS. 2B-2C in that FIG. 2A has controlled space 240A with only one region, whereas FIGS. 2B-2C have multiple regions.

As depicted in FIG. 2B, temperature-controlled truck 100 has the same components as in FIG. 2A, except controlled spaces 240B include two controlled spaces that are separated by a physical barrier. The physical barrier may be permanent or modular (e.g., a removable insulated wall), and may be implemented by an operator of temperature-controlled truck 100. Each of controlled spaces 240B may have dedicated evaporator sections 230B, each section having the components described with respect to evaporator section 230A in order to separately monitor and influence temperature within the controlled spaces 240B. This enables temperature-control apparatus 110 to maintain two different temperature ranges within the two different regions. Additionally or alternatively, a single evaporator section may be used, with different fans, valves, and control mechanisms to control cooling operations in each controlled space 240B. While not depicted, wiring and conduits used for power, heat exchange, and other temperature control operations performed in connection with condensing section 220C may span from condensing section 220B to each evaporator section 230B. FIG. 2C is duplicative of FIG. 2B, except for illustrating that evaporator sections 230C can be scaled to any number of controlled spaces 240C, each section having its own one of evaporator sections 230C. While aligned pairs of evaporator sections 230C have shared components as depicted, in some embodiments, each may have their own physically separated evaporator section. While not depicted, wiring and conduits used for power, heat exchange, and other temperature control operations performed in connection with condensing section 220C may span from condensing section 220C to each evaporator section 230C. Controlled sections 240B are shown as laterally adjacent to one another as one example; however, vertical stacking of controlled sections 240B are within the scope of the disclosure as well, as is any other configuration.

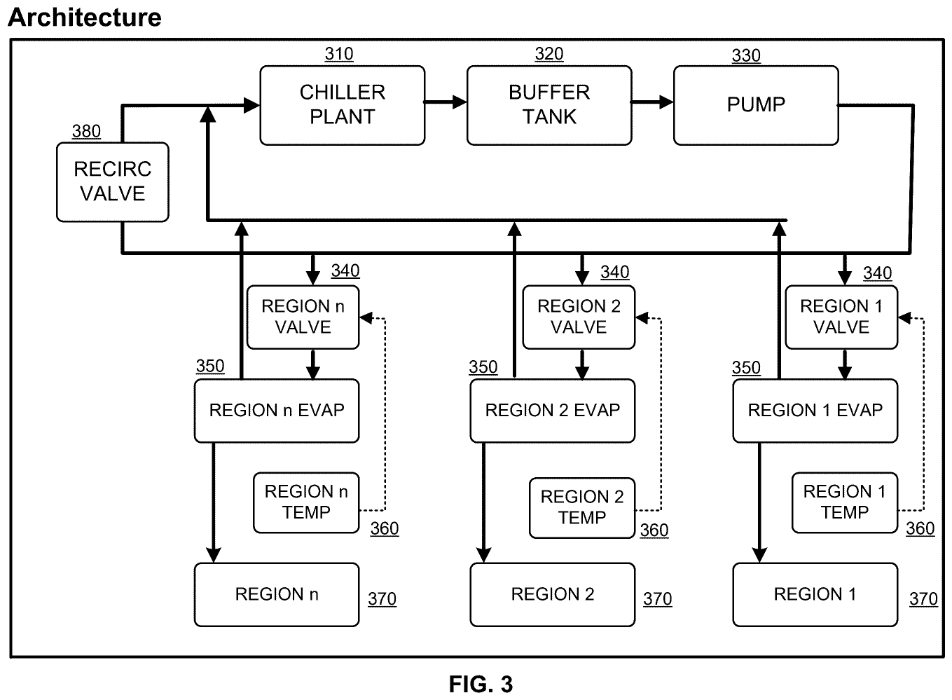

FIG. 3 illustrates a process flow for temperature-controlled regions within a storage compartment on a temperature-controlled truck in accordance with an embodiment. Cooling fluid, or coolant, as used herein may refer to “a cooling fluid which serves a primary purpose of removing heat from the pods or temperature-controlled zones. As depicted in FIG. 3, the coolant travels through a closed loop to the individual controlled spaces (referred to as “regions” as depicted in FIG. 3), where it is used to cool the air of the individual within the region. The process of FIG. 3C may be controlled individually by each evaporator section 230 within temperature-controlled truck 100.

As depicted in FIG. 3, chiller plant 310 removes heat from coolant thereby cooling, or chilling the coolant. Chiller plant 310 may be located within condensing section 220 of temperature-control apparatus 110. The coolant may be chilled inside chiller plant 310 and/or inside buffer tank 320 (which may also be located within condensing section 220). Chiller plant 310 expels heat to cool down the fluid (e.g., liquid and/or gas). Chiller plant 310 may have variable power output and/or variable flow (e.g., used in optimizations disclosed herein). Buffer tank 320 acts as a reservoir (both volumetrically and thermally) and as an expansion tank. Chiller plant 310 may have variable power output and consumption, chilling with different levels of intensity or shutting off depending on the demands of temperature-control apparatus 110. Pump 330 pumps the chilled coolant out of the buffer tank, where the coolant is transferred in a closed loop to one or more regions 240 of truck 100. Pump 330 may have variable power output and/or variable flow depending on control signals, pumping the coolant at an optimal rate to achieve temperature constraints demanded at each region while maximizing efficiency. Regions 240 may be sealed to an heat exchanger (e.g., evaporator sections 230 or other cooling mechanism) using a sealing device, such as a gasket. Each controlled section 240 may individually use a valve 340 to output the coolant from the closed loop of truck 100 to an evaporator 350 (e.g., evaporator sections 230) within a controlled section. Evaporator is non-limiting, and any heat exchanger may be used, such as a cold plate, a radiator, etc.

The heat exchanger can be any type of heat exchanger, such as liquid-to-air, liquid-to-liquid, air-to-air, direct expansion phase change evaporator, and/or any other type of heat exchanger. Valves 340 may be any valving system, such as a solenoid and/or motorized valving system, that allows individual control of coolant fluid flow into each compartment in the system. Valves 340 may be enabled or disabled by a control signal (e.g., based on temperature within the region, where when the temperature is too hot/cold and/or the rate of change of the temperature is outside a threshold tolerance, a control signal to enable/disable the valve is in place). When a valve 340 is open for a given region, coolant fluid is able to travel to that region's evaporator 350. Evaporator 350 acts as a sink for heat within the pod, effectively cooling the pod as heat is absorbed.

Each region may have a temperature sensor 360, which feeds back to its respective valve 340 through a control loop, where responsive to a target temperature not being met, the valve 340 continues to release more coolant fluid for heat removal until such a time that the target temperature is reached within the region 370 connected to the valve 340.

A recirculation valve 380 may be used to aid in coolant flow operations. In some embodiments, recirculation valve 380 may be instructed to be closed to force more coolant into one or more regions in order to accelerate cooling in those regions. In some embodiments, the recirculation valve 380 may be instructed to be open while the region valves 340 are instructed to be closed to put the vehicle in a recirculation state.

In some embodiments, as a non-limiting example, the chiller can effectively cool between 5 L and 10 L of fluid to −20 C. In some embodiments, each region 370 is fitted with a temperature and a humidity sensor that reports the readings locally to an edge device as well as to a centralized (e.g., on prem or cloud-based) computing system, where the computing system may instruct the target temperature and may instruct whether further coolant fluid should flow to a given region. Based on target set temperature and existing environmental conditions, local and/or remote systems can make decisions to control aspects of the systems to increase or decrease workload (such as increase fan speed or battery discharge rate) to maintain optimal conditions. In some embodiments, the chiller system of FIG. 3 (that is, the chiller plant, pump, and buffer tank) may be replaced with thermoelectric modules or a traditional compressor and condenser. The coolant fluid then travels and is controlled by the same valving system described above to cool each individual region 370 to different temperatures.

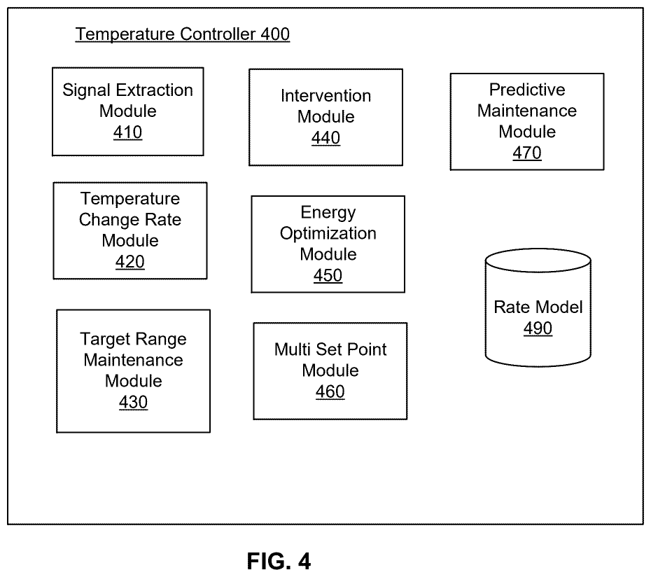

FIG. 4 illustrates exemplary modules and databases for controlling temperature in each temperature-controlled compartment of the truck, in accordance with an embodiment. As depicted in FIG. 4, temperature controller 400 (which may be part of temperature-control apparatus 110) includes various modules and databases, including signal extraction module 410, temperature change rate module 420, target range maintenance module 430, intervention module 440, energy optimization module 450, multi set point module 460, and predictive maintenance module 470, as well as rate model database 490. The modules and databases depicted in FIG. 4 are merely exemplary; fewer or additional databases and/or modules may be used to achieve the functionality disclosed herein.

Signal extraction module 410 obtains a set of signals from each region of the plurality of individually temperature-controlled regions (e.g., regions 240). Signal extraction module 410 may extract these signals from sensors of temperature-control apparatus 110. Exemplary sensors may include CO2 sensors, PM2 sensors, temperature sensors, cameras (RGB cameras, infrared cameras, etc.), humidity sensors, and any other sensor for measuring a measurable quantity within a given region. Sensors may be separately deployed on a per-region basis. Signal extraction module 410 may additionally obtain signals from other components of truck 100 (e.g., battery, remaining gas, etc.), and from other components of temperature-control apparatus or ambient readings (e.g., remaining power from temperature-control apparatus 100, ambient temperature outside temperature-controlled truck 100, sunlight intensity, ambient humidity, global positioning system (GPS) information (e.g., current location, destination location, time to destination, etc.), and any other measurable data corresponding to a truck's trajectory (e.g., speed, velocity, acceleration, traffic, etc.). Signal extraction module 410 may receive inputs from both internal and external sensors.

Temperature change rate module 420 determines, for each region, based on the extracted signals, a predicted rate of change of temperature. That is, based on the sensor input, temperature change rate module 420 may determine change information indicative of whether a region is heating or cooling at a rate that will put the region out of a target range (e.g., too hot or too cold relative to target temperature boundaries, such as recommended temperature range for transporting food) within a threshold amount of time. In order to determine the temperature change rate, temperature change rate module 420 may input the set of signals into rate model 490, and may receive as output from rate model 490, for a given region of the plurality of individually temperature-controlled regions, a predicted rate of change of temperature.

In order to train rate model 490, temperature change rate module 420 may access training examples. The training examples may include historical extracted signal data as labeled with any combination of temperature (e.g., a set of training examples on some time cadence such as once per second, once per millisecond, once per minute, or on any other time cadence) or rate of change of temperature (e.g., as detected over some range of time). Rate model 490 may be any machine learning model, such as a convolutional neural network, a deep learning network, or any other machine learning model. Rate model 490 may apply the training data and thereby be configured to predict, for a new set of extracted signals, a predicted rate of change of temperature (e.g., on some predefined measure of future time or on a per time unit basis). Temperature change rate module 420 may capture actual rate of change of temperature and may compare it to predicted rate of change of temperature, and where these two pieces of data do not match, temperature change rate module 420 may retrain rate model 490 with updated training data corresponding to the actual rate of change.

Target range maintenance module 430 determines whether the rate of change of temperature will take a temperature of the given region out of a target range. Target range maintenance module 430 determines the target range through user input and/or computer vision operations. As an example of user input, target range maintenance module 430 may receive input from a user that a given region is to maintain at least a lower bound temperature and is to not exceed an upper bound temperature while transporting a set of objects within the given region. As an example of computer vision, target range maintenance module 430 may determine an identity of an object using computer vision. For example, an image may be captured of the object, and target range maintenance module 430 may determine the identity using the image. Determining the identity may occur using a large vision model trained to output the identity based on the image. Alternatively or additionally, target range maintenance module 430 may determine the identity based on a bar code within the image, by using pattern matching as compared to templates that each correspond to an identity, by using a machine learning model configured to output an identity based on the image, or in any other manner. Target range maintenance module 430 may query a database and/or a large language model and/or an agent configured to return a target range for the identified object. For example, it may be specified in a database entry for a perishable object to maintain the object in temperature ranging from 34 degrees to 45 degrees Fahrenheit, which would form the lower and upper bounds. Of course, rather than specify the bounds themselves, a user input may include an identification of the object, from which the bounds may be derived.

Target range maintenance module 430 may determine that the rate of change of temperature will take a temperature of the given region out of a target temperature range within a span of time (e.g., within a threshold amount of time, such as within the next 30 seconds, within the next minute, prior to estimated time to destination for object, etc.). Responsive to determining that the temperature will be taken out of the target range within the span of time, target range maintenance module 430 may determine that an intervention is to be performed in order to keep the temperature within the target range. The span of time may be dynamic or static. Static spans of time may be set on a per controlled space 240 basis, or may be set for each controlled space. The static spans of time may be set by an operator of temperature-controlled truck 100 (e.g., intervene within X minutes, or based on a static function factoring in any number of variables such as ambient temperature, time to destination, etc.). Dynamic spans of time may be determined based on a function factoring in any number of variables and/or a machine learning model. For example, target range maintenance module 430 may determine a span of time by inputting into a machine learning model any number of signals, including the static signals described in the foregoing and additional signals such as speed of temperature-controlled truck 100, traffic conditions, estimated time of arrival at drop off point of target, and so on. The machine learning model may be trained to output a span of time. In an embodiment, target range maintenance module 430 may determine the span of time to be the estimated time of arrival at a drop off destination for an object, and may determine to intervene responsive to determining that the temperature will be taken out of a target range prior to arriving at the drop off destination. Span of time is merely exemplary; target range maintenance module 430 may use other reference points, such as projected distance to be covered by temperature-controlled truck 100.

Intervention module 440 determines an intervention to be performed and executes on the intervention. The intervention may be with respect to adjusting parameters for hardware and/or software components of temperature-controlled truck 100. For example, the intervention may be with respect to increasing a refrigeration operation within a region by a certain amount until a condition is reached (e.g., for a duration of time, until a rate of change of temperature that is targeted is reached, until a target temperature is reached, etc.). In some embodiments, intervention module 440 determines the intervention by inputting one or more of the extracted signals into a machine learning model, and receiving, as output from the machine learning model, a determination of the intervention. The machine learning model may be trained using training examples having rate of change, extracted signals, target range, and the like as input, and may be labeled by an intervention taken, optionally additionally with a resulting temperature and/or a resulting altered rate of change of temperature as a label.

In some embodiments, energy optimization module 450 optimizes energy usage when performing the intervention based a plurality of energy sources including the integrated battery and one or more solar panels operably coupled to the control unit. Energy usage may be optimized by energy optimization module 450 through a combination of any of heuristics and machine learning. For example, where sun is strong, solar energy may be drained more quickly than energy from other sources such as the integrated battery. Similarly, where temperature-controlled truck 100 is connected to a grid source but sun is strong, energy optimization module 450 may switch to solar energy rather than drain grid electricity. In some embodiments, even where sun is strong, energy optimization module 450 may determine to at least partially use grid power based on projected route and historical data showing a charge load that could not be achieved by solar alone before the route is to begin.

In some embodiments, multi set point module 460 determines to perform an intervention in stages. For example, if humidity is high in a region, then rapidly cooling to a target temperature (e.g., of −18 degrees) may cause moisture in the compartment to freeze to one or more components shown in FIG. 3. In these scenarios, multi set point module 460 may first set the target temperature to 2 degrees Celsius so that condensate will drip off of affected components (e.g., a coil) instead of freezing. At this point (that is, after sufficient heat is determined to have been removed from the region), multi set point module 460 may lower the set point down to the true target temperature of −18 degrees, thereby avoiding causing moisture to freeze to the coil. This improves overall efficiency and performance of the system.

As mentioned in the foregoing, signals from a thermal camera may be part of the set of extracted signals from which feedback may be derived. This type of feedback enables temperature-control apparatus 110 to determine whether there is cargo within a region at a given time and to adjust predictions and magnitude of interventions. In addition to feeding back a signal as to whether there is cargo (e.g., a binary signal of yes or no for cargo present, e.g., determined by feeding images from the thermal camera into a machine learning model trained to output whether or not cargo is present), a thermal camera may also feed back an indication of whether there is an air leak within a compartment (e.g., also determined using a classifier). This in turn enables temperature-control apparatus 110 to adjust a magnitude of intervention (e.g., a stronger magnitude is used if a leak is present, as that leak may need further intervention than otherwise needed to compensate for the release of cool air). Moreover, this enables temperature-control apparatus 110 to determine whether an opening to the region (e.g., a door) is opened, and to make decisions based on that determination. For example, where the door is opened, rather than increase magnitude of intervention as might be performed where an air leak is present, temperature-control apparatus 110 may determine to pause fans that would otherwise force all of the cold air out of the region.

In some embodiments, temperature-control apparatus 110 takes a different approach on maintaining temperature in a region when it is detected that there is no cargo in a section and/or in all sections of temperature-controlled truck 100. Temperature-control apparatus 110 may determine, based on future plans to load cargo into one or more sections, an optimal manner of adjusting temperature ahead new cargo being loaded. For example, temperature-control apparatus 110 may determine when, with which power source, and at what intensity to perform interventions that cause the section to cool to a target range within a span of time approximating a time until the cargo will be loaded into temperature-controlled truck 100. In some embodiments, a machine learning model may take as input any combination of cargo heat absorption properties, external weather conditions, trip duration, route, and/or any aforementioned signal as input, and may output one or more interventions to optimally adjust the temperature of the section designated for the cargo.

Predictive maintenance module 470 logs activities by components within the temperature-controlled truck 100 that are associated with performing an intervention (e.g., coils, pumps, valves, evaporators, etc.). The activities may include activations and deactivations, duration of use, magnitude of output, outcome (e.g., adjustment to temperature and/or rate of change of temperature) and any other variable describing usage of a given component. The activities may be input into a machine learning model that is trained to output whether the component requires maintenance. The inputs may also include prior maintenance, age of component, and so on. The machine learning model may be trained using training examples having historical activities, component identifier, historical maintenance, and so on as labeled with whether maintenance was or was not required, and optionally labeled with a type of maintenance. The machine learning model may optionally output, for a given component, a type of maintenance that is predicted. Predictive maintenance module 470 enables an operator of temperature-controlled truck 100 to maintain components prior to failure, thereby avoiding unexpected failures during transportation of objects. In some embodiments, the temperature-control apparatus is configured to manage latent heat within the controlled regions. High humidity in a compartment, particularly when cooling to below-freezing temperatures, can lead to frost buildup on heat exchange surfaces, reducing efficiency. To mitigate this, the system may employ a desiccant-based humidity control system in conjunction with the temperature-control operations. Sensors for humidity can provide signals to the control unit, and the intervention module may activate the desiccant system to remove moisture from the air before or during cooling cycles. This two-stage approach-first removing latent heat by dehumidifying and then removing sensible heat through cooling-improves overall efficiency and prevents ice formation on key components, such as the evaporator coils. The predictive maintenance module can also log the usage of the desiccant system to forecast maintenance needs for the desiccant material or components.

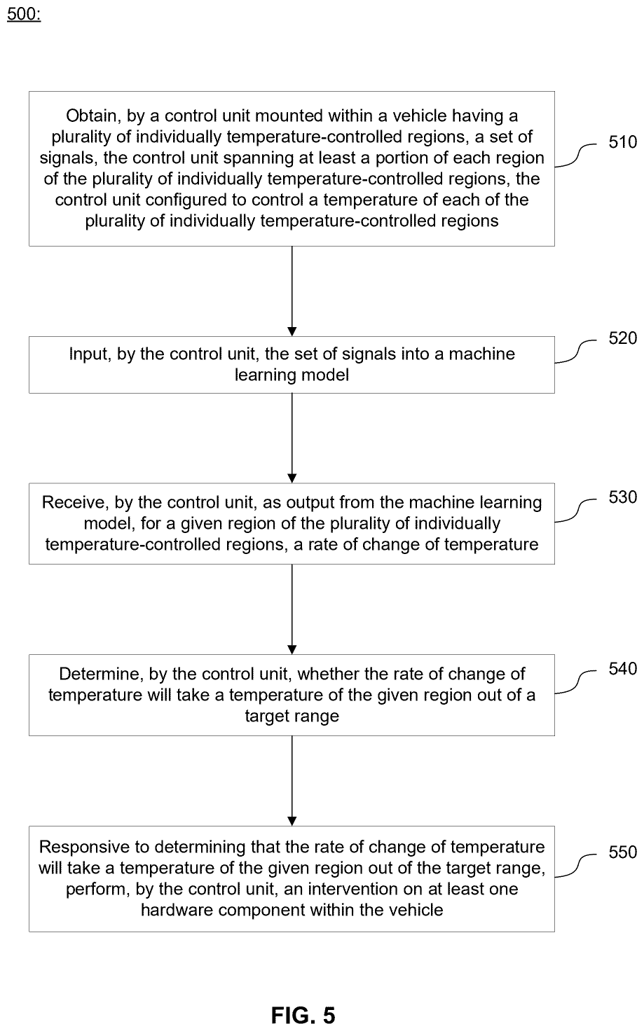

FIG. 5 depicts an exemplary process for ensuring temperature in a given region remains in a target range within the temperature-controlled truck, in accordance with an embodiment. As depicted in FIG. 5, process 500 is performed by a non-transitory computer-readable medium executing instructions that, when executed, cause one or more processors to perform operation using the modules of temperature controller 400. Process 500 begins with temperature controller 400 obtaining 510 a set of signals (e.g., using signal extraction module 410), the control unit spanning at least a portion of each region of the plurality of individually temperature-controlled regions, temperature controller configured to refrigerate each of the plurality of individually temperature-controlled regions; Temperature controller 400 inputs 520 the set of signals into a machine learning model, and receives 530, as output from the machine learning model (e.g., rate model 490), for a given region of the plurality of individually temperature-controlled regions, a rate of change of temperature (e.g., using temperature change rate module 420);

Temperature controller 400 determines 540 whether the rate of change of temperature will take a temperature of the given region out of a target range (e.g., using target range maintenance module 430). Responsive to determining that the rate of change of temperature will take a temperature of the given region out of the target range, temperature controller 400 performs 550 an intervention on at least one hardware component within the vehicle (e.g., using intervention module 440).

In some embodiments, temperature-controlled truck 100 may be any road vehicle, rather than a truck. The road vehicle may include a temperature-control apparatus mounted on a vehicle and having a condensing section and a plurality of evaporator sections, each evaporator section configured to independently monitor and influence the temperature within its corresponding controlled space. The road vehicle may include a control unit integrated with the temperature-control apparatus and configured to manage the temperature of the plurality of individually temperature-controlled regions. The road vehicle may include a dedicated power supply operably coupled to the control unit and configured to draw energy from a plurality of sources, including an integrated battery and at least one external power source such as solar panels.

The road vehicle may include a plurality of sensors configured to provide a set of signals including at least one of temperature, humidity, thermal images, GPS location, elevation, ambient temperature, or sunlight intensity, as well as a pump configured to circulate a coolant fluid through a closed loop to the plurality of regions within the vehicle. The road vehicle may include a plurality of valves, each located at a corresponding region and configured to individually control the flow of the coolant into its corresponding region. The temperature-control apparatus may have a dedicated power supply that is galvanically isolated from other low voltage buses of the vehicle. In some embodiments, the power system may be sufficiently low voltage it does not require galvanic isolation. In some embodiments, the temperature-control apparatus includes a compressor and a buffer tank, the compressor configured to adjust the temperature of the coolant and the buffer tank configured to act as a volumetric and thermal reservoir.

In some embodiments, a method is deployed for autonomous temperature-control in a refrigerated or temperature-controlled storage space within a vehicle. A control unit may obtain a diverse set of signals from a plurality of sensors within the vehicle, the signals including internal data from the vehicle's compartments and live external data such as ambient temperature and GPS location. The control unit may input the diverse set of signals into a first machine learning model to predict a rate of change of temperature for a given region. The control unit may determine whether the predicted rate of change will cause the temperature of the given region to fall outside a target range within a dynamically determined span of time. Responsive to the determination, the control unit may perform an intervention on at least one hardware component within the vehicle to maintain the temperature within the target range. The set of signals may include input from a thermal camera used to determine whether cargo is present and whether an air leak is present within a region. The intervention may be determined by a second machine learning model that considers energy sources, cargo presence, and potential air leaks.

The control unit may optimize energy usage based on a plurality of energy sources including solar panels, by prioritizing the use of solar energy when sunlight is strong. The intervention may be performed in a multi-stage process, including adjusting the temperature of a region to a first set point above freezing, determining that sufficient heat has been removed from the region, and subsequently adjusting the temperature of the region to a second set point below freezing. The control unit may log activities of components within the vehicle, including activations, deactivations, and duration of use. The control unit may generate a prediction that a given component is to be maintained based on the logged activities.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for optimizing performance of an attention layer adapter through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
obtaining, by a control unit mounted within a vehicle having a plurality of individually temperature-controlled regions, a set of signals, the control unit spanning at least a portion of each region of the plurality of individually temperature-controlled regions, the control unit configured to control a temperature of each of the plurality of individually temperature-controlled regions;
inputting, by the control unit, the set of signals into a machine learning model;
receiving, by the control unit, as output from the machine learning model, for a given region of the plurality of individually temperature-controlled regions, a rate of change of temperature;
determining, by the control unit, whether the rate of change of temperature will take a temperature of the given region out of a target range; and
responsive to determining that the rate of change of temperature will take a temperature of the given region out of the target range, performing, by the control unit, an intervention on at least one hardware component within the vehicle.

2. The method of claim 1, wherein the intervention is determined by:
inputting one or more of the set of signals into a second machine learning model; and
receiving, as output from the second machine learning model, a determination of the intervention.

3. The method of claim 1, wherein the control unit comprises an integrated battery within the control unit that powers temperature-control operations comprising one or more of refrigeration and heating.

4. The method of claim 3, wherein performing the intervention comprises optimizing energy usage based a plurality of energy sources comprising the integrated battery and one or more solar panels operably coupled to the control unit.

5. The method of claim 1, wherein performing the intervention comprises:
refrigerating the region to a first set point above freezing;
determining that sufficient heat has been removed from the region; and
refrigerating the region to a second set point below freezing.

6. The method of claim 1, further comprising:
logging activities by components within the vehicle associated with performing the intervention; and
generating a prediction that a given component is to be maintained at a given time based on the logged activities performed by the given component.

7. The method of claim 1, wherein the vehicle is an electric truck.

8. The method of claim 1, wherein the set of signals are obtained from sensors that comprise a thermal camera that feeds back information on whether a given region is exposed to air outside of the given region.

9. A non-transitory computer-readable medium comprising memory with instructions encoded thereon and one or more processors that, when executing the instructions, are caused to perform operations, the instructions comprising instructions to:
obtain, by a control unit mounted within a vehicle having a plurality of individually temperature-controlled regions, a set of signals, the control unit spanning at least a portion of each region of the plurality of individually temperature-controlled regions, the control unit configured to control a temperature of each of the plurality of individually temperature-controlled regions;
input, by the control unit, the set of signals into a machine learning model;
receive, by the control unit, as output from the machine learning model, for a given region of the plurality of individually temperature-controlled regions, a rate of change of temperature;
determine, by the control unit, whether the rate of change of temperature will take a temperature of the given region out of a target range; and
responsive to determining that the rate of change of temperature will take a temperature of the given region out of the target range, perform, by the control unit, an intervention on at least one hardware component within the vehicle.

10. The non-transitory computer-readable medium of claim 9, wherein the intervention is determined by:
inputting one or more of the set of signals into a second machine learning model; and
receiving, as output from the second machine learning model, a determination of the intervention.

11. The non-transitory computer-readable medium of claim 9, wherein the control unit comprises an integrated battery within the control unit that powers temperature-control operations comprising one or more of cooling and heating.

12. The non-transitory computer-readable medium of claim 11, wherein the instructions to perform the intervention comprise instructions to optimize energy usage based a plurality of energy sources comprising the integrated battery and one or more solar panels operably coupled to the control unit.

13. The non-transitory computer-readable medium of claim 9, wherein the instructions to perform the intervention comprise instructions to:
control the temperature of the region to a first set point above freezing;
determine that sufficient heat has been removed from the region; and
control the temperature of the region to a second set point below freezing.

14. The non-transitory computer-readable medium of claim 9, the instructions further comprising instructions to:
log activities by components within the vehicle associated with performing the intervention; and
generate a prediction that a given component is to be maintained at a given time based on the logged activities performed by the given component.

15. The non-transitory computer-readable medium of claim 9, wherein the vehicle is an electric truck.

16. The non-transitory computer-readable medium of claim 9, wherein the set of signals are obtained from sensors that comprise a thermal camera that feeds back information on whether a given region is exposed to air outside of the given region.

17. A system comprising:
memory with instructions encoded thereon; and
one or more processors that, when executing the instructions, are caused to perform operations comprising:
obtaining, by a control unit mounted within a vehicle having a plurality of individually temperature-controlled regions, a set of signals, the control unit spanning at least a portion of each region of the plurality of individually temperature-controlled regions, the control unit configured to control a temperature of each of the plurality of individually temperature-controlled regions;
inputting, by the control unit, the set of signals into a machine learning model;
receiving, by the control unit, as output from the machine learning model, for a given region of the plurality of individually temperature-controlled regions, a rate of change of temperature;
determining, by the control unit, whether the rate of change of temperature will take a temperature of the given region out of a target range; and
responsive to determining that the rate of change of temperature will take a temperature of the given region out of the target range, performing, by the control unit, an intervention on at least one hardware component within the vehicle.

18. The system of claim 17, wherein the intervention is determined by:
inputting one or more of the set of signals into a second machine learning model; and
receiving, as output from the second machine learning model, a determination of the intervention.

19. The system of claim 17, wherein the control unit comprises an integrated battery within the control unit that powers temperature-control operations comprising one or more of cooling and heating.

20. The system of claim 19, wherein performing the intervention comprises optimizing energy usage based a plurality of energy sources comprising the integrated battery and one or more solar panels operably coupled to the control unit.
